(19) United States
(12) Patent Application Publication
(10) Pub. No.: US 2024/0123652 A1
(43) Pub. Date: Apr. 18, 2024

(54) METHOD AND MANUFACTURING SYSTEM FOR PREPARING ADAPTIVE STEEL-FIBER-REINFORCED PRECAST CONCRETE MEMBERS

(71) Applicant: Hebei University of Technology, Tianjin (CN)

(72) Inventors: Longbang QING, Tianjin (CN); Li WANG, Tianjin (CN); Ru MU, Tianjin (CN); Hongjun WANG, Tianjin (CN); Mengdi BI, Tianjin (CN)

(21) Appl. No.: 18/451,809

(22) Filed: Aug. 17, 2023

(30) Foreign Application Priority Data
Oct. 13, 2022 (CN) 202211251818.1

(51) Int. Cl. B28B 1/52; B28B 1/00; B28B 17/00; B28B 23/02; B33Y 10/00; B33Y 50/00; B33Y 70/00; C04B 14/10; C04B 14/48; C04B 24/26

(52) U.S. Cl. CPC B28B 1/523; B28B 1/001; B28B 17/0072; B28B 23/022; B33Y 10/00; B33Y 50/00; B33Y 70/00; C04B 14/10; C04B 14/48; C04B 24/2664; C04B 2103/302

(57) ABSTRACT

The present disclosure provides a method and a manufacturing system for preparing adaptive steel-fiber-reinforced precast concrete members, the manufacturing system comprising: a discharging control mechanism, a mixing mechanism, a direction adjustment mechanism for steel fibers, and a 3D printing mechanism, all of which are set in sequence and connected to each other, and both the discharging control mechanism and the direction adjustment mechanism are connected to a same locator; the method comprising: S1: performing a microscopic numerical simulation, obtaining a distribution diagram, thereby constructing a model of the distribution of direction and number of the steel fibers; S2: calculating the mixing ratio, preparing a pre-mixed mortar, and weighing the steel fibers for subsequent use; S3: planning the printing path and comprehensively analyzing the printing path and the model; S4: sending information at each part of the printing path and controlling the distribution at each part of the printing path.

### CROSS REFERENCE

This application claims priority benefits to Chinese Patent Application No. 202211251818.1, filed Oct. 13, 2022, the contents of which are incorporated herein by reference.

### TECHNICAL FIELD

The present disclosure relates to the technical field of steel fiber concrete, in particular to a method and a manufacturing system for preparing adaptive steel-fiber-reinforced precast concrete members.

### BACKGROUND

Concrete is a kind of quasi-brittle materials, adding steel fibers to concrete can significantly improve its mechanical properties. It is well known that only the steel fibers that are parallel to the direction of tensile stress can exert the reinforcement effect. However, in the traditional steel fiber concrete, the steel fibers are randomly distributed in the matrix. Some fibers that are not parallel to the direction of tensile stress or that do not bridge the crack may not play a role in reinforcement, thus these fibers are not helpful to the increase of mechanical properties. Therefore, if the direction of steel fibers can be controlled so that the steel fibers are distributed along the direction of the principal tensile stress in the concrete matrix, the utilization rate of steel fibers can be maximum and the mechanical properties can be improved accordingly.

The main methods to improve the mechanical properties of concrete by controlling the direction of steel fiber include electromagnetic field driving method and 3D printing alignment method. Chinese patent NO. CN201010235371.X discloses an electromagnetic field driving method which utilizes the ferromagnetism of steel fibers. When the steel fibers are placed in the magnetic field generated by a solenoid, the steel fibers will be magnetized into a small magnetic needle. Driven by the magnetic force, the steel fibers will rotate to be parallel to the direction of the magnetic field. However, this method can only achieve a single certain direction of alignment. The 3D printing alignment method, like presented by Arun R, Behzad N, Ravi R, et al. Fiber orientation effects on ultra-high performance concrete formed by 3D printing. Cement and Concrete Research. 2021, 143: 106384., utilizes the wall effect. When the steel fiber concrete is extruded through the nozzle, the steel fibers are constrained by the nozzle and tend to be parallel to the printing path. However, this method can not allocate the number of fibers according to the magnitude of stress of each part of the member.

As is mentioned above, the existing steel fiber direction control methods has the following shortcomings: (1) steel fibers can only be aligned in a single specific direction, without considering the different stress directions at different parts under the service conditions of real components; (2) the number of steel fibers in the steel fiber concrete element is the same everywhere, without taking into account the different stress magnitude in different parts.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

According to a first aspect, a method for preparing adaptive steel-fiber-reinforced precast concrete members is provided, comprising the following steps:
S1: performing a microscopic numerical simulation of the members, to obtain a distribution diagram of stresses of the member under load, obtaining a distribution of direction and number of the steel fibers at each part of the member based on the distribution diagram of stresses, thereby constructing a model of the distribution of direction and number of the steel fibers;
S2: calculating the mixing ratio of a material based on the model of the distribution of direction and number of steel fibers obtained in step S1 and preparing a pre-mixed mortar mixture based on the mixing ratio; adjusting the workability of the pre-mixed mortar mixture to meet the requirements for 3D printing and weighing the steel fibers according to the mixing ratio for subsequent use;
S3: planning the printing path for pre-3D printing of the member, obtaining the printing path, comprehensively analyzing the printing path and the model of the distribution of direction and number of the steel fibers obtained by step S1, to obtain information of direction and number of the steel fibers at each part of the printing path;
S4: sending information of direction and number of the steel fibers at each part of the printing path obtained by step S3 to a locator; controlling the distribution of direction and number of the steel fibers at each part of the printing path in real-time by using the locator when a manufacturing system for 3D printing is performing 3D printing;
step S4 further comprises the following steps:
S41: obtaining a current position by using the locator and sending the number of steel fibers to be added and the amount of pre-mixed mortar to be added at the current position to a discharging control mechanism of the manufacturing system, conveying the steel fibers to be added and the pre-mixed mortar to be added to a mixing mechanism of the manufacturing system by using the discharging control mechanism and mixing the steel fibers and the mortar by using the mixing mechanism to prepare the pre-mixed mortar mixture, and conveying the mixture to a direction adjustment mechanism for steel fibers after mixing is completed;
S42: controlling the direction adjustment mechanism by using the locator to adjust the direction of the steel fibers, so that the direction of the steel fibers in the mixture matches the direction of stress at the current position, then conveying the mixture to a 3D printing mechanism of the manufacturing system and performing 3D printing to form the member;
step S42 further comprises the following steps:
S421: transferring the mixture which has been mixed by step S42 to a pre-orienting unit located at the top of the direction adjustment mechanism, so that the direction of the steel fibers is parallel to the direction in which the mixture is conveyed;
S422: adjusting the direction of the steel fibers again so that the direction of the steel fibers is parallel to the direction of stress at the current position when the mixture falls into a direction adjustment unit which is located at the bottom of the direction adjustment mechanism; and,
each of the second to fourth solenoid groups is a solenoid pair, comprising two solenoids respectively on two sides which are symmetric about the extrusion direction and are around the extrusion passage; when two solenoids respectively on two sides symmetric about the extrusion direction are energized, a magnetic field with a direction parallel to the extrusion direction is formed in the extrusion passage, and when passing through the extrusion passage, the steel fibers in the mixture are magnetically rotated to a direction parallel to the extrusion direction; and when two solenoids respectively on two sides not symmetric about the extrusion direction are energized, a magnetic field with a direction at an angle to the extrusion direction is formed in the extrusion passage, and the steel fibers are driven to rotate to a direction parallel to the direction of the magnetic field.

According to a second aspect, a manufacturing system for preparing adaptive steel-fiber-reinforced precast concrete members is provided, comprising:
a discharging control mechanism, a mixing mechanism, a direction adjustment mechanism for steel fibers, and a 3D printing mechanism, all of which are set in sequence and connected to each other, and both the discharging control mechanism and the direction adjustment mechanism are connected to a same locator.

The above aspects or examples and advantages, as well as other aspects or examples and advantages, will become apparent from the ensuing description and accompanying drawings.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a schematic diagram of a structure of a manufacturing system for preparing adaptive steel-fiber-reinforced precast concrete members according to the present application;

FIG. 2 is an example stress distribution diagram of an open-hole plate made of a cement-based composite material reinforced by steel fibers under uniaxial tensile stress according to the present application;

FIG. 3 is an example relationship diagram between the printing path of an open-hole plate made of the cement-based composite material reinforced by steel fibers and the distribution of direction and number of steel fibers according to the present application;

FIG. 4 is a schematic diagram of a load for a uniaxial tensile test according to the present application;

FIG. 5 is an example comparison diagram comparing the strength and toughness of the sample under uniaxial tensile stress for a test group and that of a control group according to the present application;

FIG. 6 is a schematic flowchart of a method for preparing adaptive steel-fiber-reinforced precast concrete members according to the present application;

FIG. 7 is a schematic flowchart of step S4 in FIG. 6;

FIG. 8 is a schematic flowchart of step S42 in FIG. 6;

FIG. 9 is a schematic flowchart of step S5 in FIG. 6;

FIG. 10 is a schematic flowchart of the mixing step of the mixing mechanism according to the present application;

FIG. 11 is an example block diagram of a manufacturing system in FIG. 1;

FIG. 12 is a table of the parameters of materials used in step S2 in FIG. 6;

FIG. 13 is a table of parameters of exemplary discharging control mechanism according to the present application;

FIG. 14 is a table of parameters of exemplary mixing mechanism according to the present application;

FIG. 15 is a table of parameters of an exemplary direction adjustment mechanism according to the present application;

### REFERENCE NUMBER

1—discharging control unit for steel fibers; 2—discharging control unit for cement; 3—extrusion passage; 4—mixing motor; 5—pre-mixing unit; 6—helical blade; 7—manual baffle; 8—main mixing unit; 9—additional mixing unit; 10—discharging controller; 11—discharging bin; 12—valve for both weighing and discharging; 13—horizontal screw conveyor; 14—extrusion outlet.

### DETAILED DESCRIPTION OF THE EMBODIMENTS

The present disclosure will be further described in detail below with reference to the drawings. A preferred embodiment is described in the drawings. However, the present disclosure can be implemented in many different forms and is not limited to the embodiments described herein. Rather, these embodiments are provided to provide a thorough understanding of the present disclosure. The specific embodiments are only explanations of the present disclosure, and the embodiments are not intended to limit the present disclosure. Rather, various modifications may be made in the details within the scope and range of equivalents of the claims and without departing from the present disclosure.

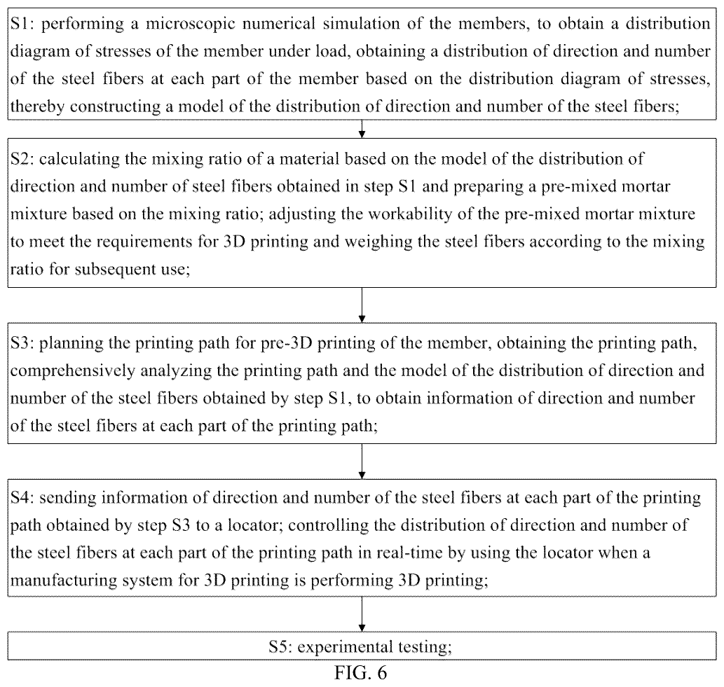

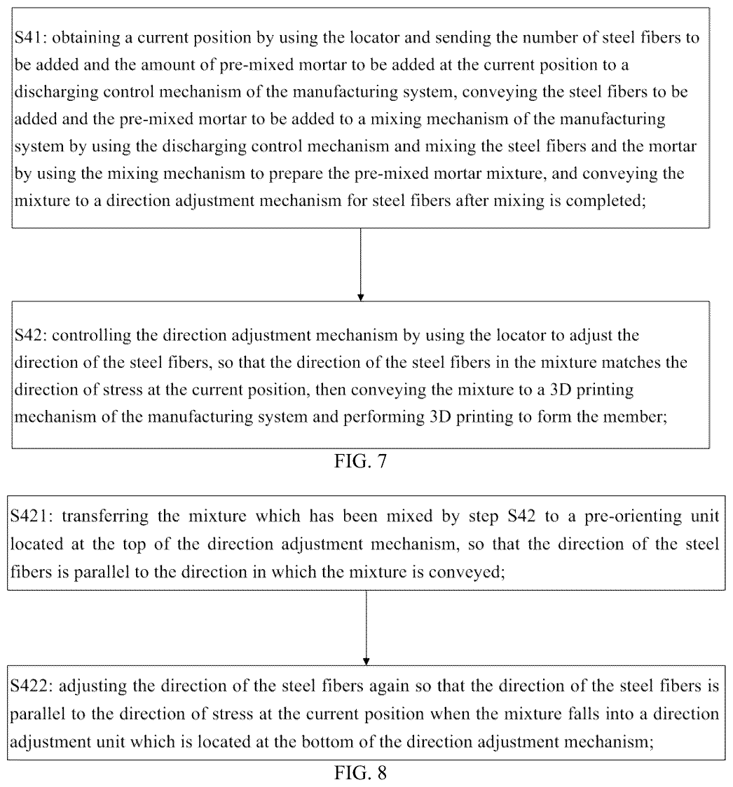

FIG. 6 shows a schematic flowchart of a method for preparing adaptive steel-fiber-reinforced precast concrete members according to the present application; FIG. 7 shows a schematic flowchart of step S4 in FIG. 6; FIG. 8 shows a schematic flowchart of step S42 in FIG. 6;

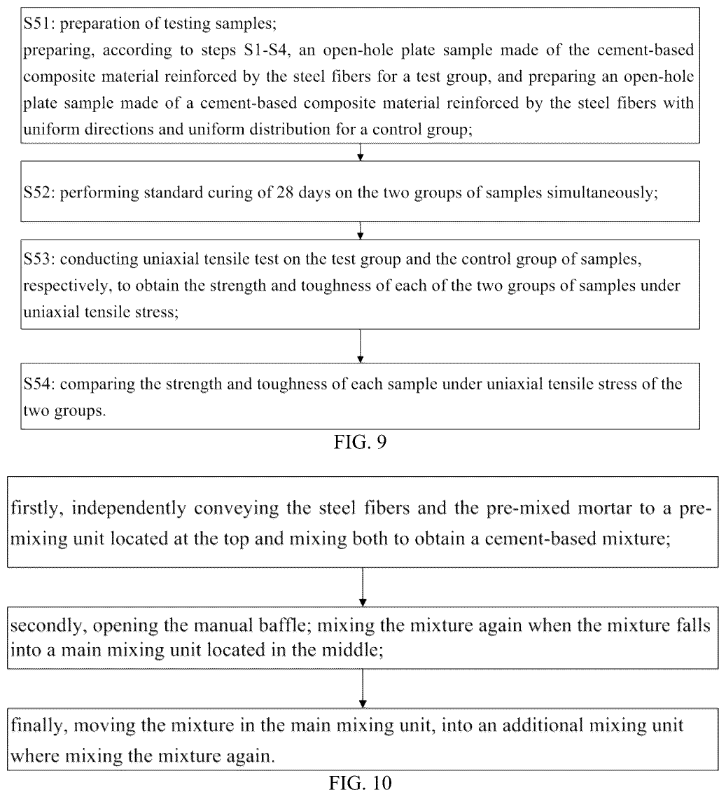

FIG. 9 shows a schematic flowchart of step S5 in FIG. 6; FIG. 10 shows a schematic flowchart of the mixing step of the mixing mechanism according to the present application; as shown in FIG. 6-FIG. 10, the present application provides a method for preparing adaptive steel-fiber-reinforced precast concrete members, which discloses the following steps comprising:
S1: performing a microscopic numerical simulation of the members, to obtain a distribution diagram of stresses of the member under load, obtaining a distribution of direction and number of the steel fibers at each part of the member based on the distribution diagram of stresses, thereby constructing a model of the distribution of direction and number of the steel fibers;
S2: calculating the mixing ratio of a material based on the model of the distribution of direction and number of steel fibers obtained in step S1 and preparing a pre-mixed mortar mixture based on the mixing ratio; adjusting the workability of the pre-mixed mortar mixture to meet the requirements for 3D printing and weighing the steel fibers according to the mixing ratio for subsequent use;

Preferably, the mixing parameters used in step S2 has the following characteristics:
materials used to make a cementitious material comprising P. O. 42.5 cement, and nano-clays with a particle diameter of less than 5 μm;
in some embodiments, the particle diameter of the nano-clays is in the range of 1-10 microns;
a water reducer of polycarboxylic type, with a water reduction efficiency greater than 50% (the water reduction efficiency of ordinary water reducers is in the range of 30%-40%, rarely more than 40%, and difficult to reach more than 50%);
the steel fiber used has a length of 25 mm, a diameter of 0.5 mm, a tensile strength of 1500 MPa, and an elastic modulus of 300 GPa (ordinary steel fiber has a tensile strength of about 1200 MPa and an elastic modulus of 210 GPa);
S3: planning the printing path for pre-3D printing of the member, obtaining the printing path, comprehensively analyzing the printing path and the model of the distribution of direction and number of the steel fibers obtained by step S1, to obtain information of direction and number of the steel fibers at each part of the printing path;
S4: sending information of direction and number of the steel fibers at each part of the printing path obtained by step S3 to a locator; controlling the distribution of direction and number of the steel fibers at each part of the printing path in real-time by using the locator when a manufacturing system for 3D printing is performing 3D printing;

Preferably, step S4 further comprises the following steps:
S41: obtaining a current position by using the locator and sending the number of steel fibers to be added and the amount of pre-mixed mortar to be added at the current position to a discharging control mechanism of the manufacturing system, conveying the steel fibers to be added and the pre-mixed mortar to be added to a mixing mechanism of the manufacturing system by using the discharging control mechanism and mixing the steel fibers and the mortar by using the mixing mechanism to prepare the pre-mixed mortar mixture, and conveying the mixture to a direction adjustment mechanism for steel fibers after mixing is completed;
preferably, the mixing mechanism in step S41 is a multi-stage mechanism, the mixing step of the mixing mechanism further comprising the following steps:
firstly, independently conveying the steel fibers and the pre-mixed mortar to a pre-mixing unit 5 located at the top and mixing both steel fibers and mortar to obtain the pre-mixed mortar mixture;
secondly, opening the manual baffle 7; mixing the mixture again when the pre-mixed mortar mixture falls into a main mixing unit 8 located in the middle;
finally, moving the mixture in the main mixing unit 8, into an additional mixing unit 9 where mixing the mixture again;
S42: controlling the direction adjustment mechanism by using the locator to adjust the direction of the steel fibers, so that the direction of the steel fibers in the mixture matches the direction of stress at the current position, then conveying the mixture to a 3D printing mechanism of the manufacturing system and performing 3D printing to form the member;

Preferably, step S42 further comprises the following steps:
S421: transferring the mixture which has been mixed by step S42 to a pre-orienting unit located at the top of the direction adjustment mechanism, so that the direction of the steel fibers is parallel to the direction in which the mixture is conveyed;
S422: adjusting the direction of the steel fibers again so that the direction of the steel fibers is parallel to the direction of stress at the current position when the mixture falls into a direction adjustment unit which is located at the bottom of the direction adjustment mechanism;

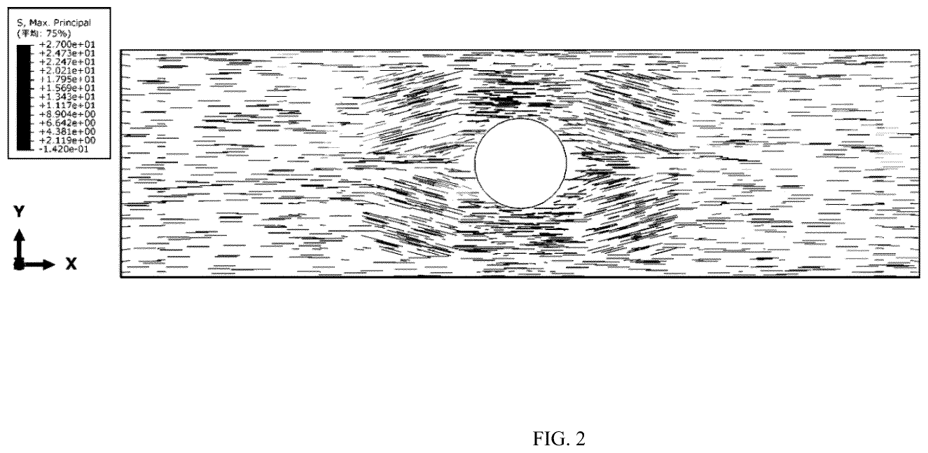

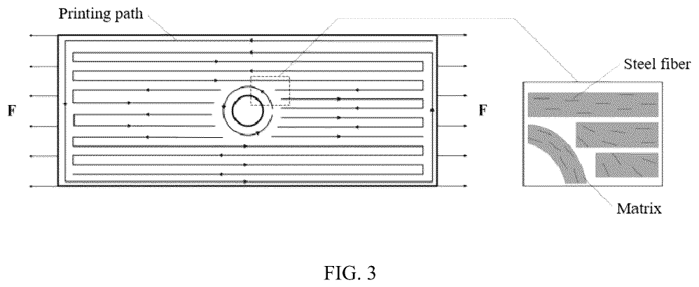

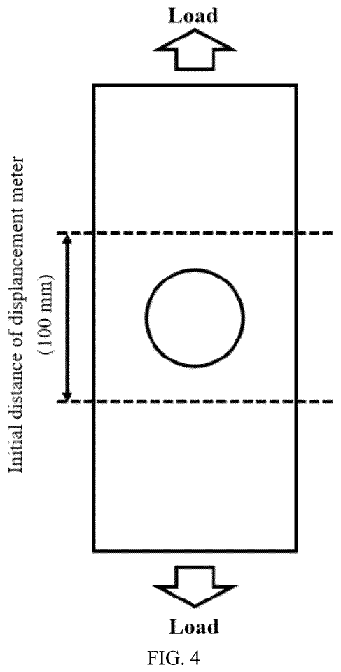

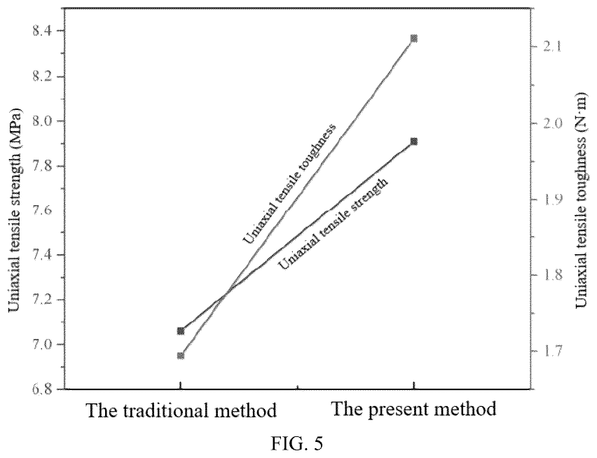

FIG. 2 shows an example stress distribution diagram of an open-hole plate made of a cement-based composite material reinforced by steel fibers under uniaxial tensile stress according to the present application; FIG. 3 shows an example relationship diagram between the printing path of an open-hole plate made of the cement-based composite material reinforced by steel fibers (e.g. the pre-mixed mortar mixture) and the distribution of direction and number of steel fibers according to the present application; FIG. 4 shows a schematic diagram of a load for a uniaxial tensile test according to the present application; FIG. 5 shows an example comparison diagram comparing the strength and toughness of the sample under uniaxial tensile stress for a test group and that of a control group according to the present application; as shown in FIG. 2-FIG. 5, preferably, step S4 is followed by:
S5: experimental testing;
preferably, step S5 further comprises the following steps:
S51: preparation of testing samples;
preparing, according to steps S1-S4, an open-hole plate sample made of the cement-based composite material reinforced by the steel fibers (e.g. the pre-mixed mortar mixture) for a test group, and preparing an open-hole plate sample made of a cement-based composite material reinforced by the steel fibers (e.g. the pre-mixed mortar mixture) with uniform directions and uniform distribution for a control group;
S52: performing standard curing of 28 days on the two groups of samples simultaneously;
S53: conducting uniaxial tensile test on the test group and the control group of samples, respectively, to obtain the strength and toughness of each of the two groups of samples under uniaxial tensile stress;
S54: comparing the strength and toughness of each sample under uniaxial tensile stress of the two groups.

The experiment was carried out in Hebei University of Technology. According to this embodiment, the open-hole plate has the dimensions that the length is 350 mm, the width is 100 mm and the height is 25 mm; the hole is set in the center of the open-hole plate and the diameter of the hole is 40 mm; according to the common knowledge in the art, it is known that the strength of tensile stress of the position near the hole is greater than that of other positions of the plate and the direction of the tensile stress is at an angle with X-axis (tensile direction); the strength of tensile stresses at locations away from the hole (e.g. at both ends of the sample) is more uniform and the direction of the tensile stresses are all parallel to the direction of the X-axis; it can be concluded from the test in step 5 that comparing with the open-hole plate made of a cement-based composite material reinforced by the steel fibers with uniform direction and uniform distribution, the open-hole plate sample made by the method of the present application has a 12% increase in strength under axial tension and a 25% increase in toughness under uniaxial tensile stress. Obviously, the mechanical properties of the cement-based composite material reinforced by the steel fibers made by the method of the present application can be significantly improved, thus confirming that the method of the present application is applicable for adjusting and controlling the direction and distribution of steel fibers.

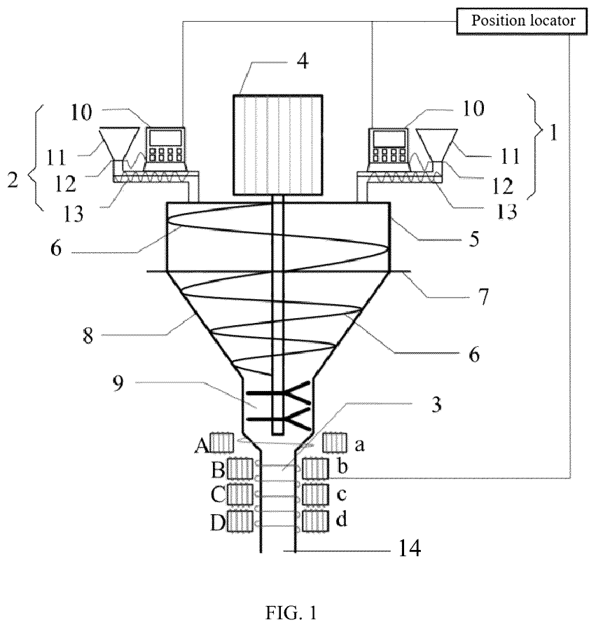

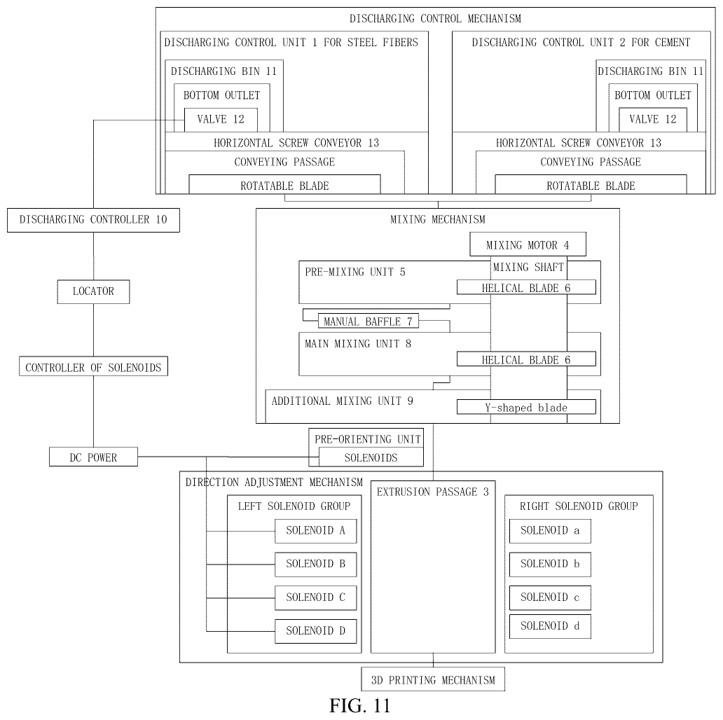

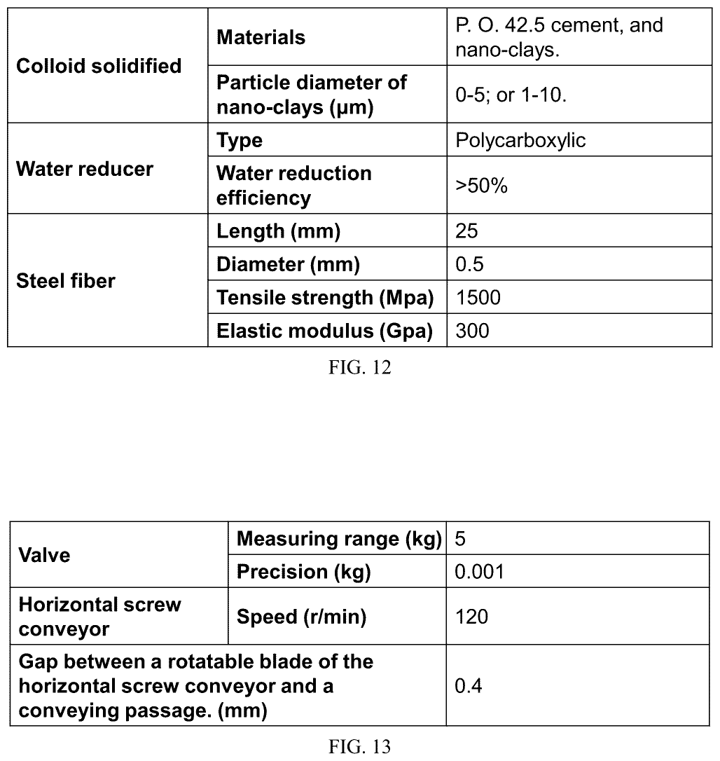

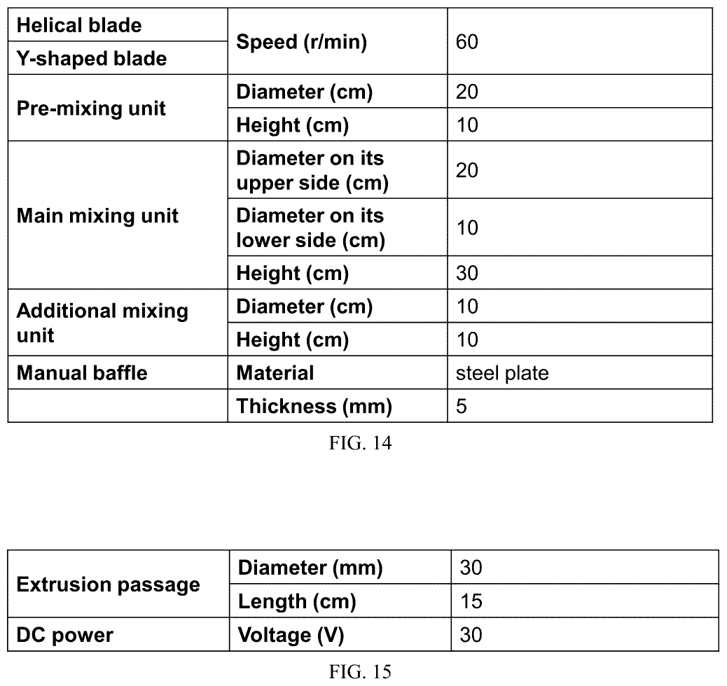

FIG. 1 shows a schematic diagram of a structure of a manufacturing system for preparing adaptive steel-fiber-reinforced precast concrete members according to the present application; FIG. 11 shows an example block diagram of a manufacturing system in FIG. 1; FIG. 12 shows a table of the parameters of materials used in step S2 in FIG. 6; FIG. 13 shows a table of parameters of exemplary discharging control mechanism according to the present application; FIG. 14 shows a table of parameters of exemplary mixing mechanism according to the present application; FIG. 15 shows a table of parameters of an exemplary direction adjustment mechanism according to the present application;

As shown in FIG. 1 and FIG. 11-FIG. 15, The present application also provides a manufacturing system for preparing adaptive steel-fiber-reinforced precast concrete members, the manufacturing system comprises a discharging control mechanism, a mixing mechanism, a direction adjustment mechanism for steel fibers, and a 3D printing mechanism, all of which are set in sequence and connected to each other, and both the discharging control mechanism and the direction adjustment mechanism are connected to a same locator. Wherein the discharging control mechanism comprises a discharging control unit 1 for steel fibers and a discharging control unit 2 for pre-mixed mortar both set above the mixing mechanism; the discharging control unit 1 for steel fibers and the discharging control unit 2 for pre-mixed mortar both comprise a discharging bin 11, a valve 12 for both weighing and discharging which is set at the bottom outlet of the discharging bin 11, and a horizontal screw conveyor 13 with one end set at the bottom of the valve 12, the valve 12 is connected to a discharging controller 10, the discharging controller 10 is connected to the locator, the other end of the horizontal screw conveyor 13 is connected to the top of the mixing mechanism. Valve 12 has a measuring range of 5 kg and a precision of 0.001 kg; the horizontal screw conveyor 13 has a speed of 120 r/min; a gap between a rotatable blade of the horizontal screw conveyor 13 and a conveying passage is less than 0.4 mm (the diameter of the steel fibers is greater than 0.5 mm) to prevent the steel fibers from getting stuck against the blade. When steel fibers and pre-mixed mortar are about to fall, two valves 12 are automatically opened, and when the amount of the two materials dropped reaches the amount preset by the discharging controller 10, two valves 12 are automatically closed.

Preferably, the mixing mechanism comprises a pre-mixing unit 5 located at the top, a main mixing unit 8 located at the middle, and an additional mixing unit 9 located at the bottom, all of which are set in a sequence from top to bottom, one end of a mixing shaft set vertically is connected to the mixing motor 4, and the other end sequentially passes through the pre-mixing unit 5, the main mixing unit 8 and the additional mixing unit 9; a bottom of the pre-mixing unit 5 and a top of the main mixing unit 8 is separated by a manual baffle 7, and a bottom of the main mixing unit 8 is connected to a top of the additional mixing unit 9; a capacity of the main mixing unit 8 is greater than the capacity of the pre-mixing unit 5, to contain the cement-based material falling from the pre-mixing unit 5.

In this Embodiment:

The pre-mixing unit 5 has a diameter of 20 cm and a height of 10 cm; the main mixing unit 8 has a diameter of 20 cm on its upper side, a diameter of 10 cm on its lower side, and a height of 30 cm; the additional mixing unit 9 has a diameter of 10 cm and a height of 10 cm.

The material of the manual baffle 7 is steel plate, and its thickness is 5 mm, to prevent deformation of the manual baffle 7 due to a long time of mixing causing the blade damaged.

Preferably, a part of the mixing shaft contained in the pre-mixing unit 5 and a part of the mixing shaft contained in the main mixing unit 8 are both fixed to a helical blade 6; a part of the mixing shaft contained in the additional mixing unit 9 is fixed to a Y-shaped blade; both the helical blade 6 and the Y-shaped blade have a speed of 60 r/min; preferably, the direction adjustment mechanism comprises an extrusion passage 3 connected to the bottom of the mixing mechanism, a pre-orienting unit located at the top, and a direction adjustment unit located at the bottom; the extrusion passage 3 has a diameter of 30 mm and a length of 15 cm; the pre-orienting unit comprises solenoids around the connecting portion between the mixing mechanism and the extrusion passage 3, the solenoids are energized by DC power to form a magnetic field with a vertical direction and uniform strength; the direction adjustment unit comprises a left solenoid group and a right solenoid group which are respectively set on two symmetric sides of the extrusion passage 3, the left solenoid group and the right solenoid group both comprise multiple solenoids which are set in a sequence from top to bottom, the solenoids are energized by a voltage of 30V, the solenoids are all connected to the locator.

By energizing the solenoids at different positions, the directions of the steel fibers can be adjusted to be parallel, perpendicular or at an angle to an extrusion direction; when energized by DC power, a first solenoid group (solenoid A and solenoid a) initially align the directions of the steel fibers, which are randomly distributed, to a single direction, as a uniform vertical magnetic field is formed, when passing through the magnetic field, the steel fibers in the mixture are driven by the magnetic force to rotate to a direction parallel to the extrusion direction, so that the directions of the steel fibers are aligned to a single direction; each of the second to fourth solenoid groups is a solenoid pair, comprising two solenoids respectively on two sides which are symmetric about the extrusion direction and are around the extrusion passage 3; when two solenoids respectively on two sides symmetric about the extrusion direction (e.g. solenoid B and solenoid b) are energized, a magnetic field with a direction parallel to the extrusion direction is formed in the extrusion passage 3, and when passing through the extrusion passage 3, the steel fibers in the mixture are magnetically rotated to a direction parallel to the extrusion direction; and when two solenoids respectively on two sides not symmetric about the extrusion direction (e.g. solenoid B and solenoid d) are energized, a magnetic field with a direction at an angle to the extrusion direction is formed in the extrusion passage 3, and the steel fibers are driven to rotate to a direction parallel to the direction of the magnetic field; The energization of the solenoids is controlled by the locator, when the 3D printing is performed for a certain position at the extrusion outlet 14, the information of stress direction of the steel fibers at that position is automatically transmitted by the locator to a controller of the solenoids, and the controller of the solenoids controls the energization of the solenoids based on the information of the stress direction of the steel fibers at the position, thereby controlling the direction of the steel fibers to be parallel to the direction of the stress at the location. The 3D printing mechanism is specifically a print head connected to the bottom side of the extrusion passage 3.

It is understandable that in some embodiments, controlling the direction of the magnetic field can be possible by combining other numbers of solenoids, for example, the direction of the magnetic field can be controlled by energizing three solenoids with the DC power, or by energizing four solenoids by the DC power, but not limited to these solutions.

It is understandable that in some embodiments, each of the first to fifth solenoid groups also comprises other numbers of solenoids such as 3, 4, 5, 6, etc., but not limited to these solutions.

The term “extrusion direction” described in the disclosure may refer to the extension direction of the extrusion channel, the direction of extrusion force, or the discharging direction of the material.

The term “vertical” described in the disclosure may refer to the extrusion direction or the direction from the top of FIG. 1 to the bottom of FIG. 1.

The term “solenoid group” described in the disclosure means a group of at least one solenoid.

The term “solenoid pair” described in the disclosure means two solenoids at any position.

The term “uniform direction” described in the disclosure means the direction of every part is the same, is substantially the same, or tends to be the same.

The term “uniform distribution” described in the disclosure means the number or amount of every part is the same, is substantially the same, or tends to be the same.

The term “two solenoids respectively on two sides symmetric about the extrusion direction” described in the disclosure means in two solenoids, one solenoid is symmetrical with respect to the extrusion direction to the other solenoid, Refer to FIG. 1, for example, solenoid A and solenoid a are respectively on two sides symmetric about the extrusion direction, solenoid B and solenoid b are respectively on two sides symmetric about the extrusion direction, solenoid C and solenoid c are respectively on two sides symmetric about the extrusion direction, solenoid D and solenoid d are respectively on two sides symmetric about the extrusion direction, but not limited to these examples.

The term “two solenoids respectively on two sides not symmetric about the extrusion direction” described in the disclosure means in two solenoids, one solenoid is not symmetrical with respect to the extrusion direction to the other solenoid, Refer to FIG. 1, for example, solenoid A and solenoid b are respectively on two sides not symmetric about the extrusion direction, solenoid B and solenoid c are respectively on two sides not symmetric about the extrusion direction, solenoid C and solenoid d are respectively on two sides not symmetric about the extrusion direction, solenoid D and solenoid a are respectively on two sides not symmetric about the extrusion direction, but not limited to these examples.

The term “first solenoid group” described in the disclosure may refer to the solenoid A and the solenoid a in FIG. 1.

The term “second solenoid group” described in the disclosure may refer to the solenoid B and the solenoid b in FIG. 1.

The term “third solenoid group” described in the disclosure may refer to the solenoid C and the solenoid c in FIG. 1.

The term “fourth solenoid group” described in the disclosure may refer to the solenoid D and the solenoid d in FIG. 1.

Therefore, according to the present application, by using the above-mentioned method for preparing adaptive steel-fiber-reinforced precast concrete members, by combining electromagnetic field technology and 3D printing technology, compared with the prior art, it is possible to automatically distribute steel fibers with a corresponding direction and a corresponding number to different areas of the member according to the level and direction of the stress at different parts of the member, thereby avoiding the traditional problem that different parts of the member can only be distributed with steel fibers with a uniform direction and uniform distribution.

The specific embodiments are only explanations of the present disclosure, and the embodiments are not intended to limit the present disclosure. Rather, various modifications may be made in the details within the scope and range of equivalents of the claims and without departing from the present disclosure. The scope of this present disclosure is not limited to the content of the description, and its technical scope shall be determined according to the scope of the claims.

In addition, it should be understood that although this specification is described in accordance with each of the embodiments, not each embodiment only contains an independent technical solution. The technical solutions in the various embodiments can also be appropriately combined to form other embodiments that can be understood by those skilled in the art without creative efforts.

What is claimed is:

1. A method for preparing adaptive steel-fiber-reinforced precast concrete members, comprising the following steps:
S1: performing a microscopic numerical simulation of the members, to obtain a distribution diagram of stresses of the member under load, obtaining a distribution of direction and number of the steel fibers at each part of the member based on the distribution diagram of stresses, thereby constructing a model of the distribution of direction and number of the steel fibers;
S2: calculating the mixing ratio of a material based on the model of the distribution of direction and number of steel fibers obtained in step S1 and preparing a pre-mixed mortar mixture based on the mixing ratio; adjusting the workability of the pre-mixed mortar mixture to meet the requirements for 3D printing and weighing the steel fibers according to the mixing ratio for subsequent use;
S3: planning the printing path for pre-3D printing of the member, obtaining the printing path, comprehensively analyzing the printing path and the model of the distribution of direction and number of the steel fibers obtained by step S1, to obtain information of direction and number of the steel fibers at each part of the printing path;
S4: sending information of direction and number of the steel fibers at each part of the printing path obtained by step S3 to a locator; controlling the distribution of direction and number of the steel fibers at each part of the printing path in real-time by using the locator when a manufacturing system for 3D printing is performing 3D printing;
step S4 further comprises the following steps:
S41: obtaining a current position by using the locator and sending the number of steel fibers to be added and the amount of pre-mixed mortar to be added at the current position to a discharging control mechanism of the manufacturing system, conveying the steel fibers to be added and the pre-mixed mortar to be added to a mixing mechanism of the manufacturing system by using the discharging control mechanism and mixing the steel fibers and the mortar by using the mixing mechanism to prepare the pre-mixed mortar mixture, and conveying the mixture to a direction adjustment mechanism for steel fibers after mixing is completed;
S42: controlling the direction adjustment mechanism by using the locator to adjust the direction of the steel fibers, so that the direction of the steel fibers in the mixture matches the direction of stress at the current position, then conveying the mixture to a 3D printing mechanism of the manufacturing system and performing 3D printing to form the member;
step S42 further comprises the following steps:
S421: transferring the mixture which has been mixed by step S42 to a pre-orienting unit located at the top of the direction adjustment mechanism, so that the direction of the steel fibers is parallel to the direction in which the mixture is conveyed;
S422: adjusting the direction of the steel fibers again so that the direction of the steel fibers is parallel to the direction of stress at the current position when the mixture falls into a direction adjustment unit which is located at the bottom of the direction adjustment mechanism; and, each of the second to fourth solenoid groups is a solenoid pair, comprising two solenoids respectively on two sides which are symmetric about the extrusion direction and are around the extrusion passage; when two solenoids respectively on two sides symmetric about the extrusion direction are energized, a magnetic field with a direction parallel to the extrusion direction is formed in the extrusion passage, and when passing through the extrusion passage, the steel fibers in the mixture are magnetically rotated to a direction parallel to the extrusion direction; and when two solenoids respectively on two sides not symmetric about the extrusion direction are energized, a magnetic field with a direction at an angle to the extrusion direction is formed in the extrusion passage, and the steel fibers are driven to rotate to a direction parallel to the direction of the magnetic field.

2. The method according to claim 1, wherein the mixing parameters used in step S2 has the following characteristics:
materials used to make a cementitious material comprising P. O. 42.5 cement, and nano-clays with a particle diameter of less than 5 μm;
a water reducer of polycarboxylic type, with a water reduction efficiency greater than 50%; and,
the steel fiber used has a length of 25 mm, a diameter of 0.5 mm, a tensile strength of 1500 MPa, and an elastic modulus of 300 GPa.

3. The method according to claim 1, wherein the mixing mechanism in step S41 is a multi-stage mechanism, the mixing step of the mixing mechanism further comprising the following steps:
firstly, independently conveying the steel fibers and the pre-mixed mortar to a pre-mixing unit located at the top and mixing both to obtain a cement-based mixture;
secondly, opening the manual baffle; mixing the mixture again when the mixture falls into a main mixing unit located in the middle; and,
finally, moving the mixture in the main mixing unit, into an additional mixing unit where mixing the mixture again.

4. The method according to claim 1, wherein step S4 is followed by:
S5: experimental testing;
step S5 further comprises the following steps:
S51: preparation of testing samples;
preparing, according to steps S1-S4, an open-hole plate sample made of the cement-based composite material reinforced by the steel fibers for a test group, and preparing an open-hole plate sample made of a cement-based composite material reinforced by the steel fibers with uniform directions and uniform distribution for a control group;
S52: performing standard curing of 28 days on the two groups of samples simultaneously;
S53: conducting uniaxial tensile test on the test group and the control group of samples, respectively, to obtain the strength and toughness of each of the two groups of samples under uniaxial tensile stress; and,
S54: comparing the strength and toughness of each sample under uniaxial tensile stress of the two groups.

5. A manufacturing system for preparing adaptive steel-fiber-reinforced precast concrete members, the manufacturing system comprising:
a discharging control mechanism, a mixing mechanism, a direction adjustment mechanism for steel fibers, and a 3D printing mechanism, all of which are set in sequence and connected to each other, and both the discharging control mechanism and the direction adjustment mechanism are connected to a same locator.

6. The manufacturing system according to claim 5, wherein
the discharging control mechanism comprises a discharging control unit for steel fibers and a discharging control unit for pre-mixed mortar both set above the mixing mechanism;
the discharging control unit for steel fibers and the discharging control unit for pre-mixed mortar both comprise a discharging bin, a valve for both weighing and discharging which is set at the bottom outlet of the discharging bin, and a horizontal screw conveyor with one end set at the bottom of the valve, the valve is connected to a discharging controller, the discharging controller is connected to the locator, the other end of the horizontal screw conveyor is connected to the top of the mixing mechanism;
the valve has a measuring range of 5 kg and a precision of 0.001 kg;
the horizontal screw conveyor has a speed of 120 r/min; and,
a gap between a rotatable blade of the horizontal screw conveyor and a conveying passage is less than 0.4 mm to prevent the steel fibers from getting stuck against the blade.

7. The manufacturing system according to claim 6, wherein
the mixing mechanism comprises a pre-mixing unit located at the top, a main mixing unit located at the middle, and an additional mixing unit located at the bottom, all of which are set in a sequence from top to bottom, one end of a mixing shaft set vertically is connected to the mixing motor, and the other end sequentially passes through the pre-mixing unit, the main mixing unit, and the additional mixing unit;
a part of the mixing shaft contained in the pre-mixing unit and a part of the mixing shaft contained in the main mixing unit are both fixed to a helical blade; a part of the mixing shaft contained in the additional mixing unit is fixed to a Y-shaped blade;
both the helical blade and the Y-shaped blade have a speed of 60 r/min;
a bottom of the pre-mixing unit and the top of the main mixing unit are separated by a manual baffle, and the bottom of the main mixing unit is connected to the top of the additional mixing unit;
a capacity of the main mixing unit is greater than the capacity of the pre-mixing unit;
the pre-mixing unit has a diameter of 20 cm and a height of 10 cm; the main mixing unit has a diameter of 20 cm on its upper side, a diameter of 10 cm on its lower side, and a height of 30 cm;
the additional mixing unit has a diameter of 10 cm and a height of 10 cm; and,
the material of the manual baffle is steel plate, and its thickness is 5 mm, to prevent deformation of the manual baffle due to a long time of mixing causing the blade damaged.

8. The manufacturing system according to claim 5, wherein
the direction adjustment mechanism comprises an extrusion passage connected to the bottom of the mixing mechanism, a pre-orienting unit located at the top, and a direction adjustment unit located at the bottom;
the extrusion passage has a diameter of 30 mm and a length of 15 cm;
the pre-orienting unit comprises solenoids around the connecting portion between the mixing mechanism and the extrusion passage, the solenoids are energized by DC power to form a magnetic field with a vertical direction and uniform strength; and,
the direction adjustment unit comprises a left solenoid group and a right solenoid group which are respectively set on two symmetric sides of the extrusion passage, the left solenoid group and the right solenoid group both comprise multiple solenoids which are set in a sequence from top to bottom, the solenoids are energized by a voltage of 30V, the solenoids are all connected to the locator.
